(19) United States
(12) Patent Application Publication
(10) Pub. No.: US 2026/0210313 A1
(43) Pub. Date: Jul. 23, 2026

(54) AERONAUTICAL PROPULSION SYSTEM

(71) Applicant: SAFRAN AIRCRAFT ENGINES, Paris (FR)

(72) Inventors: Jonathan Jean-Pierre ROUFFET, MOISSY-CRAMAYEL (FR); Zoltan ZSIGA, MOISSY-CRAMAYEL (FR)

(73) Assignee: SAFRAN AIRCRAFT ENGINES, Paris (FR)

(21) Appl. No.: 19/139,971

(22) PCT Filed: Dec. 21, 2023
(86) PCT No.: PCT/FR2023/052081

§ 371 Date: Jul. 22, 2025

(30) Foreign Application Priority Data
Dec. 21, 2022 (FR) FR2214137

(51) Int. Cl. F02K 3/06; B64D 27/10; B64D 33/00; B64D 35/00; F16H 57/04

(52) U.S. Cl. CPC F02K 3/06; B64D 27/10; B64D 33/00; B64D 35/00; F16H 57/0421; F16H 57/0436; F16H 57/0441; F16H 57/0486

(57) ABSTRACT

An aeronautical propulsion system includes a drive shaft, a fan rotor, a fan shaft that rotationally drives the fan rotor, a speed reducer, and a lubrication device. The speed reducer reduces rotationally couples the drive shaft and the fan shaft, and drives the fan shaft at a rotation speed less than a rotation speed of the drive shaft. The speed reducer includes a sun gear, a satellite, a ring gear, and a planet-carrier that is fixed with respect to a stator of the aeronautical propulsion system. The lubrication device includes a pump including a pump rotor, and an intake duct that supplies oil to the pump and axially traverses the speed reducer. Considered in an axial direction along which the aeronautical extends, the speed reducer is located between the pump and the drive shaft.

### TECHNICAL FIELD

This disclosure generally relates to the field of propulsion systems, and more specifically aeronautical propulsion systems comprising a ducted or unducted fan.

### PRIOR ART

A propulsion system generally includes, from upstream to downstream in the direction of flow of the gas, a fan section, a compressor section that may comprise a low-pressure compressor and a high-pressure compressor, a combustion chamber and a turbine section that may particularly comprise a high-pressure turbine and a low-pressure turbine. The high-pressure compressor is rotationally driven by the high-pressure turbine by way of a high-pressure shaft. The fan and where applicable the low-pressure compressor are rotationally driven by the low-pressure turbine by way of a low-pressure shaft.

Technology research efforts have already made it possible to very significantly improve the environmental performance of airplanes. The Applicant takes into consideration the factors in all the design and development phases, to obtain aeronautical components and substances that consume less energy, are more environmentally friendly, and whose integration and use in civil aviation have moderate environmental impacts, with the aim of improving the energy efficiency of aircraft.

To improve the propulsion efficiency of an aeronautical propulsion system and to reduce its specific fuel consumption, it has been found that it is advantageous to increase the rotation speed of the low-pressure turbine and of the low-pressure compressor, and to reduce the rotation speed of the fan, by means of a speed reducer.

Provision has been made for lubrication devices for lubricating such a speed reducer, to avoid the speed reducer becoming damaged. However, these lubrication devices are bulky.

### SUMMARY OF THE INVENTION

One aim of this disclosure is to make provision for lubricating a speed reducer of an aeronautical propulsion system with a lubrication device of small bulk.

For this purpose provision is made for an aeronautical propulsion system extending along an axial direction and comprising:
a drive shaft;
a fan rotor;
a fan shaft suitable for rotationally driving the fan rotor;
a speed reducer rotationally coupling the drive shaft and the fan shaft, and configured to drive the fan shaft at a rotation speed less than a rotation speed of the drive shaft, the speed reducer comprising:
   a sun gear having a diameter and rotationally coupled with the drive shaft,
   a satellite that meshes with the sun gear,
   a ring gear having a diameter and that meshes with the satellite, the diameter of the ring gear being greater than the diameter of the sun gear,
   a planet-carrier on which the satellite is rotationally mounted, the planet-carrier being fixed with respect to a stator of the propulsion system; and
a lubrication device comprising:
   a pump, the pump comprising a pump rotor and being configured to supply oil to the speed reducer when the pump rotor is in rotation, wherein the pump rotor is rotationally coupled with the satellite, wherein, considered along the axial direction, the speed reducer is located between the pump and the drive shaft, and
   an intake duct to supply oil to the pump, wherein the intake duct axially traverses the speed reducer.

The aeronautical propulsion system may also comprise the following optional features, taken alone or in combination whenever this is technically possible.

Optionally, the aeronautical propulsion system comprises a clutch configured to rotationally uncouple the pump rotor from the satellite when the rotation speed of the drive shaft is greater than or equal to a threshold engaging speed, and to rotationally couple the pump rotor with the satellite when the rotation speed of the drive shaft is less than the threshold engaging speed.

Optionally, the lubrication device comprises a second pump distinct from the pump comprising the pump rotor, the second pump being configured to supply oil to the speed reducer when the rotation speed of the drive shaft is greater than or equal to the threshold engaging speed.

Optionally, the threshold engaging speed has a value between 50 revolutions per minute and 800 revolutions per minute, for example between 50 revolutions per minute and 500 revolutions per minute, for example between 100 revolutions per minute and 300 revolutions per minute.

Optionally, the pump is configured to supply oil to the speed reducer when the pump rotor is in rotation in a first direction of rotation or in a second direction of rotation opposed to the first direction of rotation.

Optionally, the aeronautical propulsion system comprises an intermediate gear, the pump rotor being rotationally coupled with the satellite via the intermediate gear.

Optionally, the speed reducer comprises a plurality of satellites that mesh with the sun gear, and the lubrication device comprises a plurality of pumps each comprising a pump rotor, the plurality of pumps comprising at least two pumps and at the most as many pumps as there satellites, each pump rotor being rotationally coupled with a distinct satellite, the lubrication device being configured to lubricate the speed reducer with oil when the pump rotors are in rotation.

Optionally, the aeronautical propulsion system comprises a brake configured to lock the rotation of the pump rotor when the rotation speed of the drive shaft is less than a threshold braking speed.

### DESCRIPTION OF THE FIGURES

Other features, aims and advantages will become apparent from the following description, which is purely illustrative and non-limiting, and which must be read with reference to the appended drawings.

FIG. 1 schematically represents an aircraft comprising propulsion systems,

FIG. 2 schematically represents, in partial and section view, an example of a propulsion system in which the fan section is ducted,

FIG. 3 schematically represents, in partial and section view, an example of a propulsion system in which the fan section is unducted,

FIG. 4 schematically represents an example of a reduction mechanism in a first variant,

FIG. 5 schematically represents an example of a reduction mechanism in a second variant,

FIG. 6 schematically represents an example of a reduction mechanism and a lubrication device according to a first embodiment,

FIG. 7 schematically represents an example of a reduction mechanism and a lubrication device according to a second embodiment,

FIG. 8 schematically represents an example of a reduction mechanism and a lubrication device according to a third embodiment,

FIG. 9 schematically represents an example of a reduction mechanism and a brake according to a first embodiment,

FIG. 10 schematically represents an example of a reduction mechanism and a brake according to a second embodiment,

FIG. 11 schematically represents a brake according to an embodiment and certain parts of a lubrication device according to an embodiment,

FIG. 12 is a diagram showing operating regions of pumps as a function of a rotation speed of a drive shaft,

FIG. 13 schematically represents an example of a reduction mechanism, a brake, and a control system according to an embodiment,

FIG. 14 is a flow chart of steps of a braking method,

FIG. 15 comprises a flow chart showing embodiments of steps of the method of FIG. 14,

FIG. 16 comprises a flow chart showing embodiments of other steps of the method of FIG. 14,

In all the figures, similar elements bear identical reference numbers.

### DETAILED DESCRIPTION

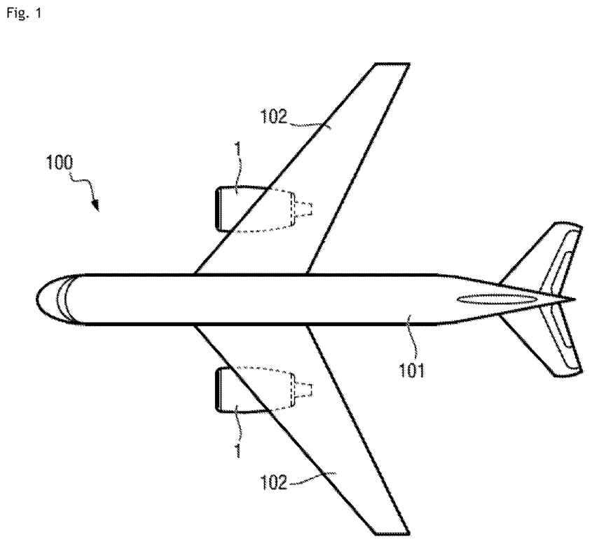

FIG. 1 shows an example of an aircraft 100. The aircraft 100 is an airplane comprising a fuselage 101 and two wings 102. In this example, the aircraft comprises two propulsion systems 1, each propulsion system 1 being attached to a respective wing 102 of the airplane 100 by way of a pylon. In another embodiment, the aircraft could comprise one or more propulsion systems attached to the fuselage 101.

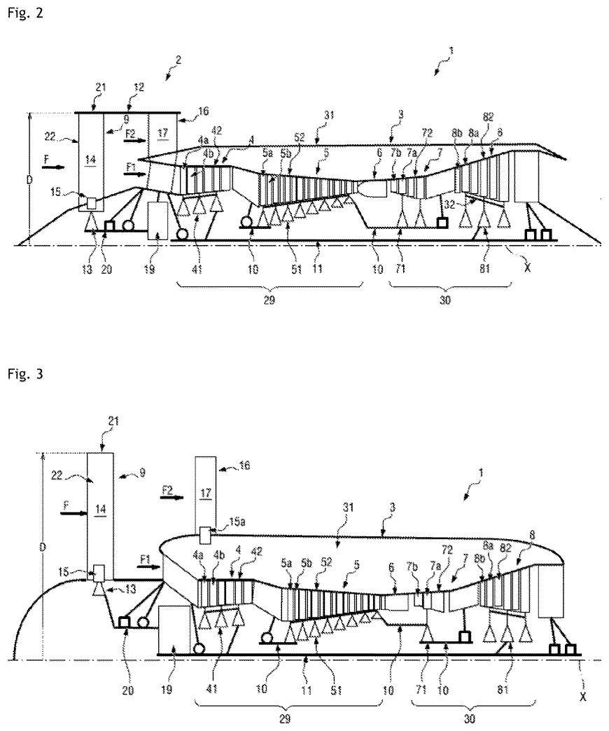

FIG. 2 schematically represents, in partial and section view, a first example of a propulsion system 1.

In this example, the propulsion system 1 is a gas turbine engine with a twin spool and a ducted fan.

On FIG. 2, the propulsion system 1 has a main direction (or axial direction) extending along a longitudinal axis X. The propulsion system 1 comprises a fan section 2 and a primary spool 3, often known as “gas generator”.

The fan section 2 comprises a fan 22 and a fan casing 12. The fan 22 comprises a fan rotor 9. The fan casing 12 surrounds the fan rotor 9. The fan rotor 9 is mounted rotatably with respect to the fan casing 12.

The fan rotor 9 comprises a fan hub 13 and fan blades 14 extending radially from the hub 13. The fan blades 14 may be fixed with respect to the fan hub 13 or have variable pitch. In the latter case, each of the fan blades 14 is mounted rotatably with respect to the fan hub 13 along a pitch axis and is connected to a pitch change mechanism 15 mounted in the propulsion system 1. The pitch change mechanism 15 makes it possible to adjust the pitch angle of the fan blades 14 as a function of the flight phases.

The pitch change mechanism 15 is in particular capable of “feathering” the fan blades 14. In a manner known per se, when the fan blades are feathered, the drag generated by the fan rotor 9 is minimal. In other words, the feathered position of the fan blades is the position that minimizes the maximum cross-section of the fan or that minimizes the fan drag with respect to the stream of air traversing the fan. In practice, the pitch angle of the fan blades 14 is of approximately 90° when the fan blades 14 are feathered.

For example, the pitch change mechanism 15 is configured to keep the fan blades feathered, when the pitch change mechanism is not controlled, for example when the propulsion system is turned off. Such a default position can be obtained by appropriate return means, such as a spring.

The fan rotor 9 comprises at least fourteen fan blades 14 and at the most twenty-four fan blades 14, for example at least sixteen fan blades 14 and at the most twenty-two fan blades 14.

In addition, in this example, the fan section 2 also comprises a fan stator 16 mounted fixedly on the fan casing 12. The fan stator 16 comprises fixed blades 17 generally known as Outlet Guide Vanes (OGV). This assembly of fixed blades has the function of straightening and regulating the air stream that flows downstream of the fan rotor 9 to optimize the thrust of the engine. This assembly of fixed blades also plays a noise-reducing 19 role.

Alternatively, the outlet vanes 17 could have a variable pitch. Where applicable, and similarly to the fan blades 14 of the fan rotor 9, the root of each of the outlet vanes 17 is mounted pivotably along an axis of pitch and is connected to a pitch change mechanism (not shown), the pitch being adjusted as a function of the flight phase by the pitch change mechanism.

The number of outlet vanes 17 depends on the acoustic criteria defined for the propulsion system 1 and is at least equal to the number of fan blades 14.

The primary spool 3 comprises a compressor section 29, a combustion chamber 6 and a turbine section 30.

The compressor section 29 comprises a low-pressure compressor 4 and a high-pressure compressor 5.

The low-pressure compressor 4 comprises a rotor 41 suitable for being rotationally driven with respect to the casing 31 of the propulsion system 1 and a stator 42 mounted fixedly on the casing 31.

The rotor 41 of the low-pressure compressor 4 comprises movable wheels 4a and the stator 42 of the low-pressure compressor 4 comprises fixed wheels 4b. The movable wheels 4a are disposed alternately with the fixed wheels 4b, thus forming a series of low-pressure compressor stages.

Similarly, the high-pressure compressor 5 comprises a rotor 51 suitable for being rotationally driven with respect to the casing 31 of the propulsion system 1 and a stator 52 mounted fixedly on the casing 31.

The rotor 51 of the high-pressure compressor 5 comprises movable wheels 5a and the stator 52 of the high-pressure compressor 5 comprises fixed wheels 5b. The movable wheels 5a are disposed alternately with the fixed wheels 5b, thus forming a series of high-pressure compressor stages.

The turbine section 30 comprises a high-pressure turbine 7 and a low-pressure turbine 8.

The high-pressure turbine 7 comprises a rotor 71 suitable for being rotationally driven with respect to the casing 31 of the propulsion system 1 and a stator 72 mounted fixedly on the casing 31.

The rotor 71 of the high-pressure turbine 7 comprises movable wheels 7a and the stator 72 of the high-pressure turbine 7 comprises fixed wheels 7b. The movable wheels 7a are disposed alternately with the fixed wheels 7b, thus forming a series of high-pressure turbine stages.

Similarly, the low-pressure turbine 8 comprises a rotor 81 suitable for being rotationally driven with respect to the casing 31 of the propulsion system 1 and a stator 82 mounted fixedly on the casing 31.

The rotor 81 of the low-pressure turbine 8 comprises movable wheels 8a and the stator 82 of the low-pressure turbine 8 comprises fixed wheels 8b. The movable wheels 8a are disposed alternately with the fixed wheels 8b, thus forming a series of low-pressure turbine stages.

The propulsion system 1 comprises a low-pressure shaft 11 connecting the rotor 81 of the low-pressure turbine 8 to the rotor 41 of the low-pressure compressor 4, the low-pressure shaft 11 being mounted rotatably with respect to the casing 31 about the longitudinal axis X.

When the propulsion system 1 is in operation, the rotor 81 of the low-pressure turbine 8 rotationally drives the rotor 41 of the low-pressure compressor 4 by way of the low-pressure shaft 11.

The propulsion system 1 further comprises a fan shaft 20 and a reduction mechanism 19. The fan rotor 9 is mounted fixedly on the fan shaft 20. The reduction mechanism 19 has an input and an output. The input of the reduction mechanism 19 is connected to the low-pressure shaft 11 and the output of the reduction mechanism 19 is connected to the fan shaft 20.

Thus, when the propulsion system 1 is in operation, the rotor 81 of the low-pressure turbine 8 rotationally drives not only the rotor 41 of the low-pressure compressor 4, but also the fan rotor 9, by way of the low-pressure shaft 11, of the reduction mechanism 19 and of the fan shaft 20.

Owing to the reduction mechanism 19, the fan rotor 9 is rotationally driven at a speed less than the rotation speed of the rotor 41 of the low-pressure turbine 4.

The reduction mechanism 19 thus makes it possible to independently optimize the speed of rotation of the fan 22 and the rotation speed of the low-pressure turbine 8 and of the low-pressure compressor 4.

The low-pressure turbine 8, the low-pressure shaft 11, the low-pressure compressor 4, the fan shaft 20, the reduction mechanism 19 and the fan 22 together form the “low-pressure spool” of the propulsion system 1.

The propulsion system 1 further comprises a high-pressure shaft 10 connecting the rotor 71 of the high-pressure turbine 7 to the rotor 51 of the high-pressure compressor 5, the high-pressure shaft 10 being mounted rotatably with respect to the casing 31 about the longitudinal axis X. The high-pressure shaft 10 is coaxial with the low-pressure shaft 11 and extends around the low-pressure shaft 11.

When the propulsion system 1 is in operation, the rotor 71 of the high-pressure turbine 7 rotationally drives the rotor 51 of the low-pressure compressor 5 by way of the low-pressure shaft 11.

The high-pressure turbine 7, the high-pressure shaft 10 and the high-pressure compressor 4 together form the “high-pressure spool” of the propulsion system 1.

The low-pressure shaft 11 and the high-pressure shaft 10 may be corotating, i.e. be driven in the same direction of rotation about the longitudinal axis X. In a variant, the low-pressure shaft 11 and the high-pressure shaft 10 can be contrarotating, i.e. be driven in opposite directions of rotation about the longitudinal axis X.

The twin-spool propulsion system 1 may particularly comprise a single-stage high-pressure turbine 7, i.e. comprising exactly one stage, or a two-stage high-pressure turbine 7, i.e. comprising exactly two stages (as illustrated in the example of FIG. 2).

The high-pressure compressor 5 comprises at least eight stages (as illustrated in the example of FIG. 2) and at the most eleven stages.

The low-pressure turbine 8 comprises at least three stages (as illustrated in the example of FIG. 2) and at the most five stages.

The low-pressure compressor 4 comprises at least two stages and at the most four stages.

When the propulsion system is in operation, a stream of air F entering the propulsion system 1 traverses the fan 22 then is divided between a primary air stream F1 and a secondary air stream F2, which circulate from upstream to downstream through the propulsion system 1.

The secondary air stream F2, also known as “bypass air stream”, flows through the secondary air path, around the primary spool 3. The secondary air stream F2 makes it possible to cool the periphery of the primary spool 3 and serves to generate most of the thrust supplied by the propulsion system 1.

The primary air stream F1 flows through an air path inside the primary spool 3, passing successively through the compressor section 29 (low-pressure compressor 4 and high-pressure compressor 5), the combustion chamber 6 where it is mixed with fuel to serve as comburent, and the turbine section 30 (high-pressure turbine 7 and low-pressure turbine 8). The passage of the primary air stream F1 through the turbine section 30 receiving energy from the combustion chamber 6 causes the rotation of the movable wheels 7a, 8a of the turbine section 30, which in turn rotationally drive the movable wheels 4a, 5a of the compressor section 29 and of the fan rotor 9.

To improve the propulsive efficiency of the propulsion system 1 and reduce its specific fuel consumption as well as the noise emitted by the fan section 2, the propulsion system 1 has a high bypass ratio. The term “high” bypass ratio means a bypass ratio greater than or equal to 10, for example between 10 and 18 inclusive. The bypass ratio is defined as a ratio of the mass flow rate of the secondary air stream F2 to the mass flow rate of the primary air stream F1, these mass flow rates thereof being measured when the propulsion system 1 is static, uninstalled, in takeoff rating in a standard atmosphere (as defined by the International Civil Aviation Organization (ICAO), Doc 7488/3, 3^{rd} edition) and at sea level. The term “uninstalled” means that the measures are taken when the propulsion system 1 is in a test bed (and not installed on an aircraft), the measurements then being easier to take.

In a propulsion system, the introduction of a reduction mechanism 19 as illustrated in FIG. 2 between the fan 22 and the low-pressure turbine 8 makes it possible to reduce the rotation speed and the pressure ratio of the fan rotor 9 while increasing the power extracted by the low-pressure turbine 8. Specifically, the overall efficiency of the propulsion system 1 is first-order conditional on the propulsive efficiency, which is favorably affected by a minimization of the variation in the kinetic energy of the air passing through the propulsion system 1. In a propulsion system with a high bypass ratio, most of the flow rate generating the propulsive force is formed by the secondary air stream F2 of the propulsion system 1, the kinetic energy of the secondary air stream F2 being mostly affected by the compression that is undergone by the secondary air stream F2 during the crossing of the fan section 2. The propulsive efficiency and the pressure ratio of the fan section 2 are therefore related: the lower the pressure ratio of the fan section 2, the better the propulsive efficiency. In order to optimize the propulsive efficiency of the propulsion system 1, the pressure ratio of the fan, which corresponds to the ratio between the average pressure at the outlet of the fan stator 16 (or, in the absence of any stator 16, of the fan rotor 9) and the average pressure at the inlet of the fan rotor 9, is less than or equal to 1.70, for example less than or equal to 1.50, for example between 0.90 and 1.45. The average pressures are measured here over the height of at least one of the fan blades 14, i.e. the surface that radially delimits, inside, the air flow path at the inlet of the fan rotor 9 at the tip 21 of the fan blade 14.

The peripheral speed at the tip 21 of the fan blades 14 can moreover be between 260 meters per second (m.s-1) and 400 meters per second (m.s-1) inclusive. The fan pressure ratio may then be between 1.20 and 1.45.

In a direct-drive propulsion system, the fan rotor 9 can, alternatively, be directly coupled to the low-pressure shaft 11, i.e. without any reduction mechanism. The low-pressure shaft 11 is then colinear with the fan shaft 20 such that the fan rotor 9 driven by the low-pressure shaft 11 at the same rotation speed as the rotor 81 of the low-pressure turbine 8.

The propulsion system 1 is configured to supply a thrust between 18 000 lbf (80 068 N) and 51 000 lbf (226 859 N), for example between 20 000 lbf (88 964 N) and 35 000 lbf (155 688 N).

The diameter D of the fan rotor 9 may be between 80 inches (203.2 cm) and 185 inches (469.9 cm) inclusive. When the fan rotor 9 is ducted, the diameter D is for example between 85 inches (215.9 cm) and 120 inches (304.8 cm) inclusive, for example in the order of 90 inches (228.6 cm), which allows the integration of the propulsion system 1 conventionally, in particular under a wing of the aircraft 1.

FIG. 3 schematically represents, in partial and section view, a second example of a propulsion system 1.

On FIG. 3, components identical or similar to those of the propulsion system of FIG. 2 are referred to by identical reference numbers.

In the example illustrated on FIG. 3, the propulsion system 1 is a gas turbine engine with a twin spool and an unducted fan. It can be a gas turbine engine of Open Rotor or Unducted Single Fan type.

Unlike the first example of FIG. 2, the fan rotor 9, which can also be denoted by the term “propeller”, is not surrounded by a fan casing.

The fan section 2 being unducted, the fan blades 14 have variable pitch.

Alternatively, the propulsion system 1 could comprise two unducted and contrarotating fan rotors 9. Such a propulsion system 1 is known by the acronym CROR for Contra-Rotating Open Rotor or UDF for Unducted Double Fan. The fan rotors 9 may be placed aft of the primary spool 3 so as to be of pusher type or forward of the primary spool 3 so as to be of puller type.

The absence of any duct around the fan rotor 9 makes it possible to very significantly increase the bypass ratio without the propulsion system 1 being penalized by the mass of the casings 12 or nacelles intended to surround the fan section 2. The bypass ratio of the propulsion system 1 comprises an unducted fan section 2 is thus greater than or equal to 40, for example between 40 and 80 inclusive. The peripheral speed at the tips 21 of the fan blades 14 of the fan rotor or rotors 9 can moreover be between 210 meters per second (m.s-1) and 260 meters per second (m.s-1) inclusive. The fan pressure ratio can then be, for example, between 0.90 and 1.20 inclusive.

The diameter D of the fan rotor 9 may be between 80 inches (203.2 cm) and 185 inches (469.9 cm) inclusive. When the rotor 9 is unducted, the diameter D is for example greater than or equal to 100 inches (254 cm), for example between 120 inches (304.8 cm) and 156 inches (396.2 cm). The diameter of the fan rotor 9 is measured here in a plane normal to the longitudinal axis X, which is the axis of rotation of the fan rotor 9, at the level of an intersection between a tip 21 and a leading edge 22 of the fan blades 14.

Note that, FIG. 2 and FIG. 3 being partial views, the diameter D is only partially visible.

The reduction mechanism 19 may comprise a reduction mechanism, in this example a reduction mechanism with an epicyclic gear train, for example of “epicyclic” type or of “planetary” type according to the terminology sometimes encountered among those skilled in the art, single-stage or two-stage.

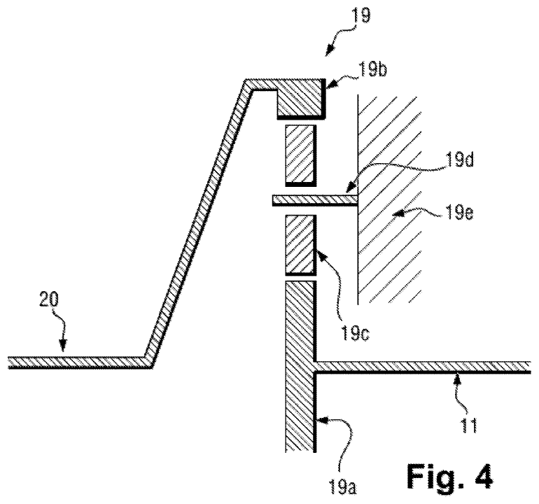

For example, FIG. 4 illustrates a reduction mechanism 19 according to a first variant of star type. The reduction mechanism 19 comprises a sun gear 19a (input of the reduction mechanism 19), centered on an axis of rotation of the reduction mechanism 19 generally colinear with the longitudinal axis X and configured to be rotationally driven by the low-pressure shaft 11, a ring gear 19b (output of the reduction mechanism 19) coaxial with the sun gear 19a and configured to rotationally drive the fan shaft 20 about its axis X of rotation, and a series of satellites 19c circumferentially distributed about the axis X of rotation of the rotor 9 of the fan section 2, between the sun gear 19a and the ring gear 19b, each satellite 19c being meshed internally with the sun gear 19a and externally with the ring gear 19b. The series of satellites 19c is mounted on a planet carrier 19d which is fixed in relation to a stator part 19e of the propulsion system 1, for example with respect to a casing of the compressor section 4, 5. In these two variants, the ring gear 19b has a diameter greater than the diameter of the sun gear 19a.

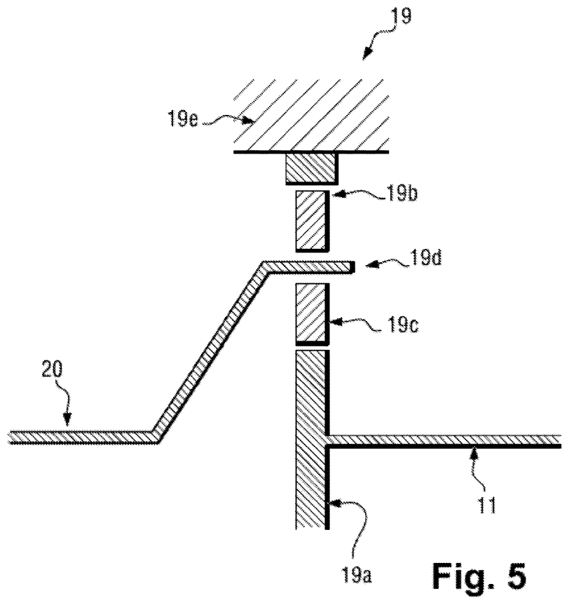

In another example, FIG. 5 illustrates a reduction mechanism 19 according to a second variant of planetary type (FIG. 4), in which case the ring gear 19b is mounted fixedly on the stator part 19e of the propulsion system 1 and the fan shaft 20 is rotationally driven by the planet carrier 19d (which is therefore rotationally movable with respect to a stator part 19e of the propulsion system 1, for example with respect to a casing of the compressor section 4, 5).

Whatever the configuration of the reduction mechanism 19, the diameter of the ring gear 19b and of the planet-carrier 19d are greater than the diameter of the sun gear 19a, such that the rotation speed of the fan rotor 9 is less than the rotation speed of the low-pressure shaft 11.

The reduction ratio of the reduction mechanism 19 is greater than or equal to 2.5 and less than or equal to 15. In the case of a propulsion system 1 comprising a ducted fan, the reduction ratio can be greater than or equal to 2.7 and less than or equal to 3.5, for example around 3.0. In the case of a propulsion system 1 comprising an unducted fan, the reduction ratio can be between 9.0 and 11.0.

To optimize the performance of the propulsion system 1, the propulsion system 1 comprises all or part of the features detailed below.

### 1) Lubrication Device for Lubricating the Reduction Mechanism

The propulsion system 1 may comprise a lubrication device 100 having the function of lubricating all or part of the reduction mechanism 19. In the remainder of this disclosure, the reduction mechanism 19 will more simply be called the “reducer 19”.

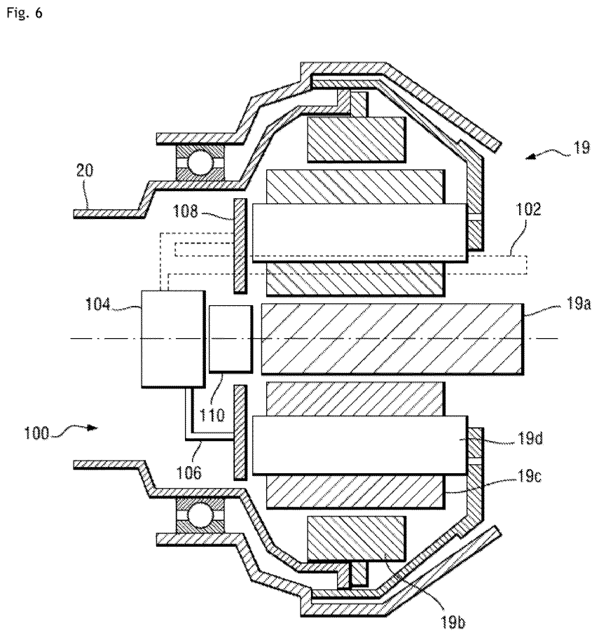

FIG. 6 shows a first embodiment of this lubrication device 100, combined with a reducer 19 of “planetary” type as previously described. Thus, the planet carrier 19d is fixed with respect to the stator 19e of the propulsion system 1, while the sun gear 19a, the satellites 19c and the ring gear 19b are rotationally movable. Furthermore, in this configuration, the sun gear 19a forms the input of the reducer 19, connected to a drive shaft (for example the low-pressure shaft described previously). The ring gear 19b is connected to the fan shaft 20. Such a “planetary” configuration allows in this example a simplification of the structure of the lubrication device, and therefore a bulk saving, related to a greater ease of integration.

The lubrication device 100 comprises an oil intake duct 102, a pump 104, an oil supply duct 106 and an oil distributor 108.

The oil intake duct 102 fluidly connects a source of oil (not illustrated) and the pump 104. The oil intake duct 102 supplies the pump 104 with oil coming from this oil source.

The oil intake duct 102 axially traverses the speed reducer 19. More precisely, the oil intake duct 102 passes between two adjacent satellites 19c of the reducer 19. This axial traversal contributes to reducing the general bulk of the lubrication device 100 by taking advantage of the unoccupied space between the two neighboring satellites 19c. The occupation of space within the engine is optimized.

In use, oil flows through the intake duct 102 toward the pump. Put still otherwise, oil flows through the oil intake 102 in a direction going toward the fan section.

The oil intake duct 106 fluidly connects the pump 104 and the oil distributor 108.

The oil distributor 108 forms an outlet of the lubrication device 100. The oil distributor is arranged to distribute the oil to a target part of the reducer 19, such that the part or parts are lubricated (sun gear 19a, satellites 19c, planet carrier, ring gear 19b, one or more bearings), and to do so in a way that is moreover known.

The pump 104 has the function of supplying oil to the speed reducer 19. When the pump 104 is active, the pump 104 pumps oil coming from the intake duct 102 and transmits oil to the oil distributor 108 via the supply duct 106. When the pump 104 is inactive, the distributor 108 is not supplied with oil by the pump 104.

Considered along the axial direction X, the reducer 19 is arranged between the pump 104 and the drive shaft 11. In other words, the pump 104 is upstream of the reducer 19 (if one refers to the direction of flow of the air stream F when the propulsion system 1 is in operation). The pump 104 is surrounded by the fan shaft 20. Such a configuration allows a bulk saving since one is using a space generally left unoccupied in the prior art, since this space is confined between the reducer and the fan shaft. The relative positioning of this space with respect to the reducer makes its use fairly counter-intuitive, particularly as regards supply lines.

The pump 104 comprises a pump rotor rotationally movable about its own axis, this axis being for example parallel to the axis X, in this example colinear with the axis X. When the pump rotor is set in rotation, the pump 104 is activated. When the pump rotor stops rotating, the pump 104 becomes inactive.

The pump rotor is rotationally coupled with a rotary element of the reducer 19. This means that the rotary element in question is connected to the pump rotor by a mechanical coupling suitable for the rotation of this element to drive the rotation of the pump rotor. The torque transmission line between the rotary element and the pump rotor is distinct from the torque transmission line between the low-pressure shaft 11 and the fan shaft 20 via the reducer 19. In this example, the rotary element is the sun gear 19a; in other words, the pump rotor is rotationally coupled with the sun gear 19a. The mechanical coupling connecting the sun gear 19a to the pump rotor does not comprise the satellites 19c or the ring gear 19b. This arrangement is not very bulky, and in particular makes it possible to make use of a space unoccupied in the prior art.

The pump 104 is for example a two-way pump 104, i.e. the pump 104 is configured to supply oil to the speed reducer 19 when the pump rotor is in rotation in a first direction of rotation or in a second other direction of rotation opposed to the first direction of rotation. This allows the lubrication of the reducer by the pump 104 whatever the direction of rotation of the fan rotor (which thus drives the pump rotor) by an external force when the engine is stopped (for example by wind on the ground or in a windmilling situation.) This moreover makes it possible to dispense with a non-return system to lock the rotation of the fan rotor 9 in a direction opposite to the direction imparted by the turbines, which makes it possible to lighten the system and reduce the overall bulk.

The pump 104 can be of any type: piston pump 104, plate pump 104, centrifugal pump 104, etc.

For example, the propulsion system comprises a clutch 110. The clutch 110 is part of the aforementioned mechanical coupling between the rotary element of the reducer 19 coupled to the pump rotor, in this example the sun gear 19a, and the pump rotor.

The clutch 110 is configurable in two positions: an engaged position and a disengaged position.

In the engaged position, the clutch 110 rotationally couples the pump rotor and the rotary element under consideration (here the sun gear 19a). In other words, the pump rotor rotates if and only if the rotary element (here the sun gear 19a) rotates when the clutch is in the engaged position. When the clutch is in the engaged position, one then refers to the pump 104 as being engaged.

In the disengaged position, the clutch 110 rotationally uncouples the pump rotor from the rotary element under consideration (here the sun gear 19a). In other words, the pump rotor is no longer mechanically linked to the rotary element, so that the pump rotor can remain rotationally immovable while the rotary element rotates, and vice versa. When the clutch is in the disengaged position, one then says that the pump 104 is disengaged.

The clutch 110 is configured to pass from the engaged position to the disengaged position when the speed of rotation of the drive shaft 11 increases and exceeds a threshold disengaging speed.

For example, the threshold disengaging speed is between 50 revolutions per minute and 800 revolutions per minute, or for example between 50 revolutions per minute and 400 revolutions per minute, or for example between 100 revolutions per minute and 300 revolutions per minute. When the pump 104 is an auxiliary pump supplementing a main pump, these speeds provide a trade-off between the size of the pump 104 and the capacity of the main pump.

Moreover, the clutch is configured to pass from the disengaged position to the engaged position when the rotation speed of the drive shaft 11 decreases and becomes less than a threshold engaging speed N_{D}.

For example, the threshold engaging speed Np is between 50 revolutions per minute and 800 revolutions per minute, or for example between 50 revolutions per minute and 400 revolutions per minute, or for example between 100 revolutions per minute and 300 revolutions per minute. When the pump 104 is an auxiliary pump supplementing a main pump, these speeds provide a trade-off between the size of the pump 104 and the capacity of the main pump.

The threshold disengaging speed can be identical to the threshold engaging speed N_{D} (which makes the clutch 110 simpler) or else be different therefrom.

If these two threshold speeds are identical, then the clutch is configured to:
rotationally uncouple the rotary element (here the sun gear 19a) if the rotation speed of the drive shaft 11 is greater than or equal to the threshold engaging speed N_{D}, and to
rotationally couple the pump rotor with the rotary element (here the gear if the rotation speed of the drive shaft 11 is less than the threshold engaging speed N_{D}.

The clutch 110 thus makes it possible for the pump 104 to be active only in the event of low speeds (start-ups, malfunctions, maintenance, etc.). Such a clutch 110 makes it possible to dimension the pump 104 as accurately as possible for the purpose of saving space. Specifically, at reduced speed, it may be possible to use a pump 104 of smaller bulk.

In a variant or as a complement, the clutch 110 can be configured to go from the disengaged position to the engaged position when an oil pressure in the intake duct decreases and becomes less than a first threshold pressure, and/or to go from the engaged position to the disengaged position when an oil pressure in the intake duct increases and exceeds a second threshold pressure.

In certain embodiments, the lubrication device 100 comprises a second pump (not illustrated) distinct from the pump 104 comprising the pump rotor, the second pump being configured to supply oil to the speed reducer 19 when the rotation speed of the drive shaft 11 is greater than or equal to the threshold engaging speed N_{D}.

For example, the pump 104 can form a so-called auxiliary pump operating as a complement or a replacement to the second pump which can form a so-called main pump also configured to lubricate the reducer 19.

The main pump is configured to lubricate the reducer 19 when the rotation speed of the drive shaft is greater than a threshold priming speed N_{A}.

The threshold priming speed N_{A} is less than or equal to the threshold engaging speed N_{D}.

When one chooses N_{A}=N_{D}, then the auxiliary pump 104 is disengaged via the clutch 110, when the main pump is used. Thus, the auxiliary pump 104 and the main pump are used in ranges of rotation speed of the drive shaft that are different.

When one chooses N_{A}<N_{D}, the main pump and the auxiliary pump 104 are simultaneously active in the speed ranges [N_{A} N_{D} [. For example, the auxiliary pump 104 can be active in a phase of priming of the main pump.

The threshold engaging speed N_{D} can allow a trade-off between the optimization of the occupation of space within the engine for the main pump and within the reducer for the auxiliary pump (the size of the pump being a function of its capacity) and the lubrication (oil flow rate) over the entire range of speeds. For example, the threshold engaging speed N_{D} can be the speed above which the main pump is primed and outputs at its nominal flow rate. The ranges of threshold engaging speed N_{D} above can be a trade-off between the size of the auxiliary pump and the capacity of the main pump.

When one chooses N_{A}=0, the main pump is used at all the rotation speeds of the drive shaft.

The lubrication device 100 may comprise a check valve (not illustrated) to prevent the reflux of oil into the pump 104. Such a valve makes it possible, when the pump 104 is an auxiliary pump 104, to avoid the oil pumped by the main pump 104 flowing back up toward the auxiliary pump 104.

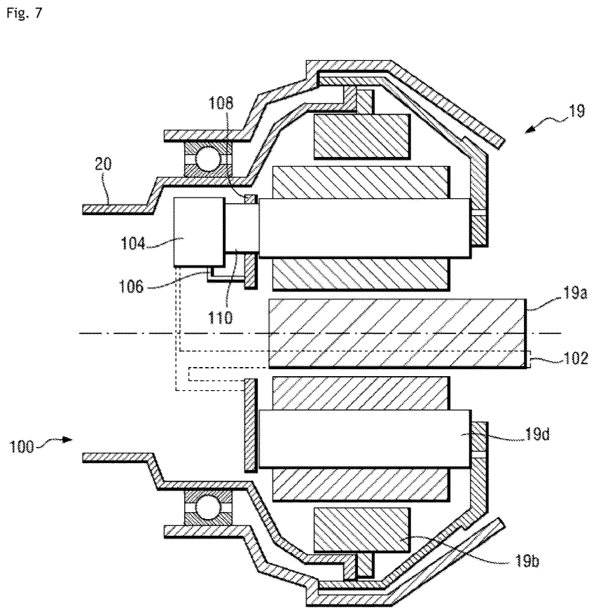

FIG. 7 shows a second embodiment of the lubrication device 100, which differs from the first embodiment by the fact that the rotary element to which the pump rotor is rotationally coupled is one of the satellites 19c of the reducer 19, and not the sun gear 19a. Thus, the satellite in question is connected to the pump rotor by a mechanical coupling suitable for rotating the satellite to drive the rotation of the pump rotor. This arrangement is not very bulky, and in particular makes it possible to make use of space unoccupied in the prior art.

Moreover, in this second embodiment, the reducer 19 is axially located between the pump 104 and the drive shaft (this configuration is also found in the first embodiment of FIG. 6).

If the choice is made, in this second embodiment, to have a threshold disengaging speed equal to the threshold engaging speed N_{D}, then the clutch 110 is configured to:
rotationally uncouple the satellite 19c to which it is connected, if the rotation speed of the drive shaft 11 is greater than or equal to the threshold engaging speed N_{D}, and to
rotationally couple the pump rotor with the satellite 19c if the rotation speed of the drive shaft 11 is less than the threshold engaging speed N_{D}.

In this second embodiment, the lubrication device 100 may comprise several pumps 104 in accordance with the preceding description, the pumps 104 being respectively coupled with different satellites 19c of the reducer 19. It is thus possible to have, in the lubrication device 100, as many pumps 104 as there are satellites 19c. In other words, the lubrication device comprises a plurality of pumps each comprising a pump rotor, the plurality of pumps comprising at least two pumps and at the most as many pumps as there are satellites, each pump rotor being rotationally coupled with a distinct satellite 19c, the lubrication device being configured to lubricate the speed reducer 19 with the oil when the pump rotors are in rotation. Such a configuration makes it possible to use small pumps, and therefore to optimize the bulk. The assembly of pumps can be dimensioned to supply oil over the entire speed range, such that it is possible to dispense with a main pump, which gives rise to a saving of space within the engine. Furthermore, such a plurality of pumps ensures a certain redundancy, and therefore improves the reliability of the lubrication device.

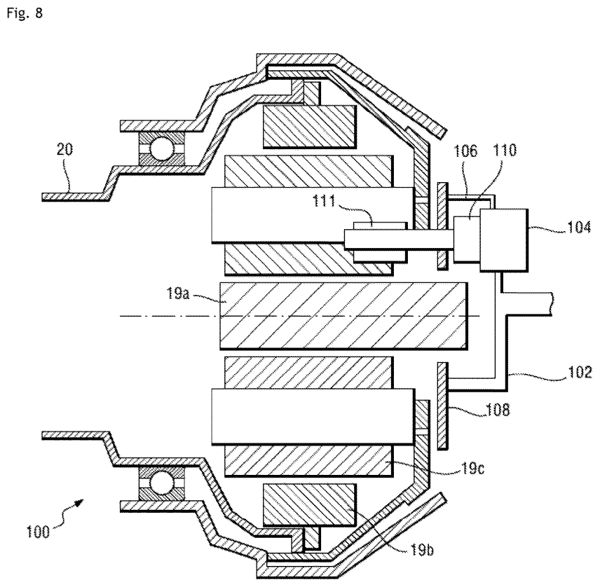

In a third embodiment shown on FIG. 8, the mechanical coupling connecting the rotary element of the reducer 19 (sun gear 19a or satellite 19c) to the pump rotor comprises an intermediate gear 111 not forming part of the reducer 19. The rotary element of the reducer 19 meshes with this intermediate gear 111, and the intermediate gear 111 is arranged to rotationally drive the pump rotor, where applicable by way of the clutch 110. Using such an intermediate gear 111 can make it possible to offset the pump 104 to optimize its location and the bulk of the system.

Moreover, in this third embodiment, the reducer 19 is axially located between the pump 104 and the fan shaft 20.

In a fourth embodiment (not illustrated), the rotary element is the ring gear 19b of the reducer 19. Thus, the ring gear 19b is connected to the pump rotor by a mechanical coupling suitable for rotating the ring gear 19b to rotationally drive the pump rotor, this mechanical coupling not involving the fan shaft 20.

In a fifth embodiment (not illustrated), the rotary element is the fan shaft 20.

### 2) Brake for Locking/Unlocking the Fan Rotor

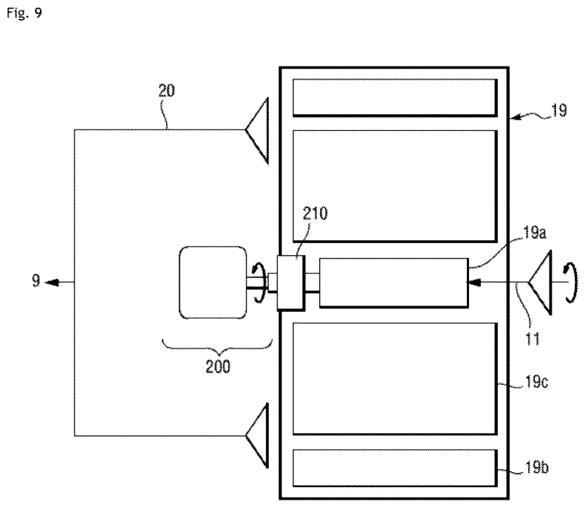

With reference to FIG. 9, the propulsion system 1 may comprise a brake 200 configured to brake a rotation of the fan rotor 9 or to lock such a rotation.

In this disclosure, “braking” or the “braking” of an element should be interpreted as the application of a force opposing the rotational motion of this element, without however locking this rotational movement. A “braking” thus has the effect of slowing down the rotation speed of the braked element. By contrast, “locking” or a “locking” of an element has the effect of reducing the rotation speed of this element to zero and therefore preventing the rotation of the element in question.

In general, the brake 200 is configured to interact with an element of the propulsion system 1, the rotation of which is dependent on the fan rotor 9. Thus, the element with which the brake 200 interacts receives the force generated by the brake 200, and this force is then transmitted directly or indirectly to the fan rotor 9 via this element. In the remainder of the text, the element with which the brake 200 interacts is known as the “element to be braked”, it being understood that the element to be braked can also be locked by the brake 200.

To generate a locking or braking force, the brake 200 is supplied with energy by an energy source. The greater the amount of energy the brake 200 receives from the energy source, the greater the force generated. Thus, the force that the brake applies to lock the element to be braked (and consequently the fan rotor 9) requires an amount of energy greater than the amount of energy required to allow the brake 200 to apply braking without locking. The source of energy used can be of any type. For example, the source of energy is a battery (in which case the energy that the brake receives is an electrical energy).

For example, the default position of the brake 200 is a position in which the brake provides a locking of the fan rotor 9. The term “default position” should be understood to mean the position that the brake 200 takes when the brake 200 is not supplied with energy, in particular when the propulsion system 1 is turned off. Such a default position can be obtained by appropriate return means, such as a spring.

Moreover, the brake 200 can be configured to permit the rotational movement of the fan rotor 9 via a manual control (i.e. to be released manually), when the propulsion system 1 is turned off, i.e. when the combustion chamber is extinguished. This simplifies maintenance of the system.

The brake 200 may be of any type (disc type, dog type, etc.). Any type of actuation of the brake 200 may be envisioned (electrical, pneumatic, hydraulic).

The propulsion system 1 may comprise a clutch 210.

The brake 200 is configured to be disengaged by the clutch 210 when a rotation speed of the drive shaft 11 increases and exceeds a first threshold speed. This first threshold speed can also be referred to as a second threshold disengaging speed (to avoid confusing it with the threshold disengaging speed used by the clutch 110 already described in section 1). Owing to this, the safety and reliability of the propulsion system 1 is increased since it avoids having a brake that can be enabled in flight.

For example, the first threshold speed (or second threshold disengaging speed) is for example between 50 revolutions per minute and 800 revolutions per minute, for example between 50 revolutions per minute and 400 revolutions per minute, for example between 100 revolutions per minute and 300 revolutions per minute.

Moreover, the brake 200 is configured to be engaged by the clutch 210 when a rotation speed of the drive shaft 11 decreases and becomes less than a second threshold speed (or second threshold engaging speed, not to be confused with the threshold engaging speed of the clutch 110 described in section 1). The operational ranges are thus optimized and safety increased: specifically, the brake is disengaged more quickly in the event of an acceleration, but the brake is rendered operational more quickly in the event of a deceleration.

The second threshold speed (or second threshold engaging speed) is for example between 50 revolutions per minute and 800 revolutions per minute, for example between 50 revolutions per minute and 400 revolutions per minute, for example between 100 revolutions per minute and 300 revolutions per minute.

The first threshold speed and the second threshold speed used by the clutch 210 may be equal (which makes it possible to simplify the system) or different.

When the first threshold speed and the second threshold speed used by the clutch 210 are equal, then the clutch 210 can be configured to:
rotationally uncouple the pump rotor from the sun gear 19a, from the satellite gear 19c, from the ring gear 19d, from the fan shaft 20 or from the drive shaft 11 if the rotation speed of the drive shaft 11 is greater than or equal to the first threshold speed, and to
rotationally couple the pump rotor with the sun gear 19a, the satellite gear 19c, the ring gear 19d, the fan shaft 20 or the drive shaft 11 if the rotation speed of the drive shaft 11 is less than the first threshold speed.

The first threshold speed used by the clutch 210 can be identical or different from the threshold disengaging speed used by the clutch 110 defined in section 1. The second threshold speed used by the clutch 210 can be identical or different from the threshold engaging speed N_{D} used by the clutch 110 defined in section 1.

The brake 200 can moreover comprise a fuse (or safety section), configured to mechanically uncouple the brake 200 from the rest of the propulsion system 1. For example, the fuse comprises a mechanical portion configured to break as soon as a threshold force is reached within the mechanism. This makes it possible to increase the safety in the event of untimely and accidental actuation of the brake 200 in flight. Specifically, in this case, the fuse section can break and the fan rotor 9 can then continue to rotate.

FIG. 9 shows a first embodiment of the brake 200 in which the clutch 210 is different from the clutch 110. In this first embodiment, the clutch 210 is arranged to couple or uncouple the sun gear 19a and the brake 200.

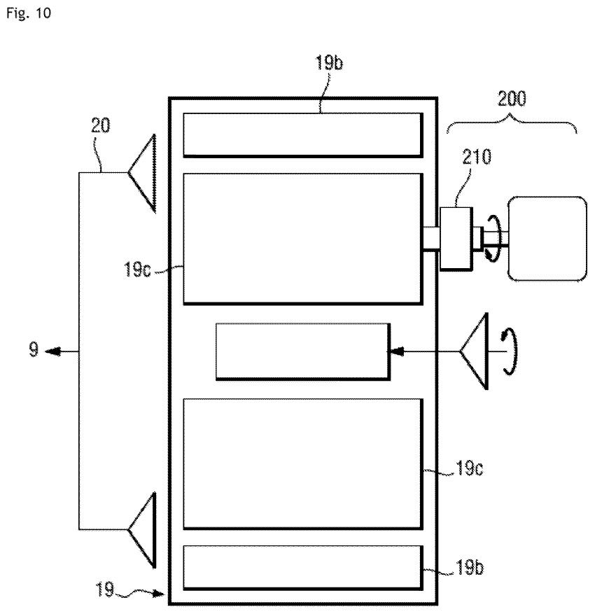

FIG. 10 shows a second embodiment of the brake 200 in which the clutch 210 is different from the clutch 110. In this embodiment, the clutch 210 is arranged to couple or uncouple one of the satellites 19c and the brake 200.

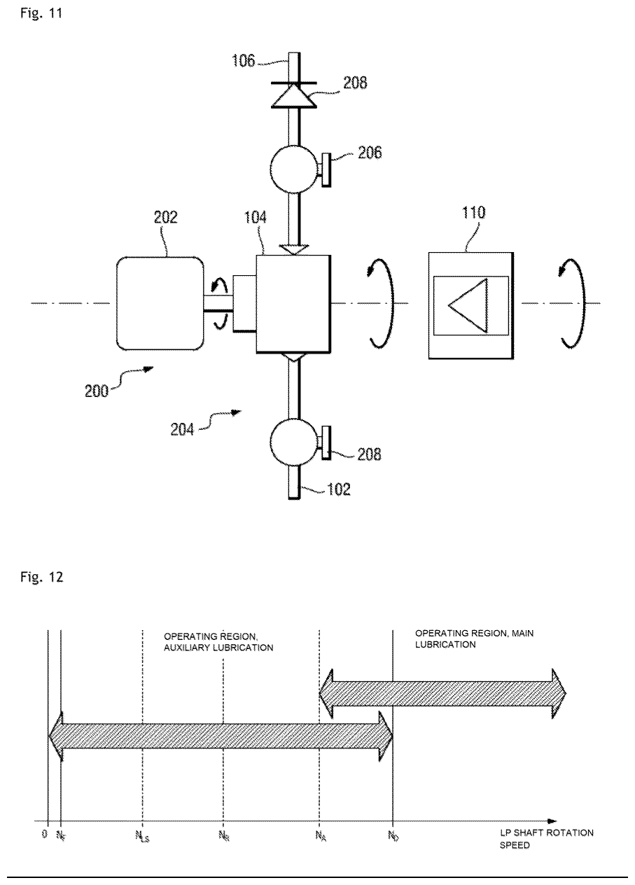

FIG. 11 shows a third embodiment of the brake 200 in which the clutch 210 and the clutch 110 are in fact one and the same clutch.

In this third embodiment, the second threshold engaging speed is the threshold engaging speed N_{D} defined in section 1, and the second threshold disengaging speed is the threshold disengaging speed defined in section 1 (which can be equal to N_{D}). The element to be braked is, in this embodiment, the rotor of the pump 104. Thus, the same clutch 110 is used to control the activation of the pump 104, and therefore the lubrication of the reducer 19, and moreover to ensure that the brake 200 is properly uncoupled from the reducer 19, to guarantee that any involuntary actuation of the brake 200 has no effect on the reducer 19, particularly in mid-flight.

The brake 200 is configured to brake the rotation of the pump rotor when the rotation speed of the drive shaft 11 is less than a threshold braking speed N_{R}. This makes it possible to limit the movements of the fan rotor, and reduces the need for oil to lubricate the reducer 19. Specifically, since the speed is reduced, it may be possible to use a smaller oil reservoir, a smaller pump etc. Furthermore, by choosing the rotor of the pump 104 as the element to be braked, one thus obtains a fully integrated lubrication and braking system (at least at low speed), of reduced bulk and reduced mass. Furthermore, the braking phase may allow a possible gradual locking where applicable and avoid damaging the propulsion system 1.

For example, the threshold braking speed N_{R} is between 30 revolutions per minute and 500 revolutions per minute, for example between 50 revolutions per minute and 300 revolutions per minute, for example between 80 revolutions per minute and 180 revolutions per minute. Braking above such a speed makes it possible to dimension the pump with a satisfactory trade-off between the bulk, the capacity/flow rate and the braking capacity (a small flow rate makes it possible to use a pump of small size).

Moreover, the brake 200 is configured to lock the rotation of the element to be braked when the rotation speed of the drive shaft 11 is less than a threshold locking speed N_{F}. The threshold locking speed N_{F} is less than the threshold braking speed N_{R}. With such a locking, it is not necessary to lubricate the reducer over the braking range, the dimensioning of the pump 104 can be optimized, and the integration of the systems is improved, as is ground safety (the fact that the fan rotor is locked avoids accidents).

For example, the threshold locking speed N_{F} is between 0 revolutions per minute and 200 revolutions per minute, for example between 0 revolutions per minute and 50 revolutions per minute, for example between 0 revolutions per minute and 20 revolutions per minute. Locking above such a speed makes it possible to dimension the pump 104 with a satisfactory trade-off between bulk, capacity/flow rate and braking capacity.

In the embodiment of the brake shown in FIG. 11, the brake 200 comprises a mechanical brake 202 and a system of valves 204.

The mechanical brake 202 is for example a friction brake suitable for exerting friction on the pump rotor, for example a disc brake. Such a brake is relatively compact.

Moreover, the system of valves 204 comprises a first controlled valve 206 downstream of the pump 104 and a second controlled valve 208 upstream of the pump 104.

The first valve 206 is arranged in the supply duct 106. The second valve 208 is arranged in the intake duct 102. Each of the two valves 206, 208 can be open, to let oil pass through, and closed, to prevent the passage of oil. When the first valve 206 is closed, it prevents the oil coming from the pump 104 from being conveyed to the fluid distributor 110. When the second valve 208 is closed, it prevents the oil coming from the oil source from being conveyed to the pump 104 via the oil intake duct 102.

To perform a locking, the system of valves 204 can be actuated as follows. The first downstream valve 206 is closed, then the second upstream valve 208 is closed. This has the effect of putting the pump 104 in overpressure and blocking any flow of oil at the inlet/outlet of the pump 104, which has the consequence of rotationally locking the pump rotor. To release the hydraulic brake 204, it suffices to open first the downstream valve and then the upstream valve. The rotation of the pump rotor is again permitted after releasing the brake.

The system of valves 204 may also comprise a check valve 208 suitable for gradually increasing the pressure within the pump 104 and thus performing a braking without locking.

The system of valves 204 described above is particularly compact and light (particularly by comparison with a mechanical locking/unlocking system).

For example, the system of valves 204 can be dedicated to the locking of the pump rotor, while the mechanical brake 202 can be dedicated to braking (slowing without locking). In a variant, the mechanical brake can be used to participate in the braking and to participate in the locking.

Combining the system of valves 204 and the mechanical brake 202 within the brake 200 makes it possible to optimize the lubrication performance on the one side and the braking performance on the other. However, the brake 200 may comprise only the system of valves 204 previously discussed (the brake 200 then does not comprise any mechanical brake). The brake 200 is then even more compact and light. Alternatively, the brake 200 can be composed of the mechanical brake 202 previously discussed (the brake 200 then does not comprise any system of valves).

The control of the brake 200 can be a function of at least one state of operation of the lubrication device 100.

The brake 200 can be hydraulically controlled, the hydraulic control being fluidly connected to the lubrication device 100. This makes it possible to make the brake more compact, and offers the opportunity of using a nearby energy source.

To implement this hydraulic control, the brake 200 may comprise a switch for enabling and disabling the brake. When the brake is disabled, the brake cannot generate any braking force, even if a certain amount of energy also reaches it via the energy source previously discussed. It is only when the brake is enabled that such an energy can be converted by the brake into a braking/locking force. The enabling of the brake 200 can then be conditional on the activation of the pump 104. For example, the switch can be operated by the oil circulating through the lubrication device 100 into a position that enables the brake 200. If no such fluid circulates, the switch is brought into another position that disables the brake, for example using return means, such as a spring.

Of course the brake 200 is compatible with all the embodiments of the lubrication device 100 described in section 1). In particular, the brake 200 can be combined with the embodiments of the lubrication device 100 in which the pump rotor is rotationally coupled with the sun gear 19a (FIG. 6) or with a satellite 19c (FIGS. 7 and 8). One then obtains a synergistic effect, since the braking is performed on “fast” gears in rotation and transmitting less torque. One then benefits from the reduction ratio of the reducer 19 in terms of torque to be applied, reducing the braking force and therefore the size of the brake 200.

### 3) Regions of Operation of the Lubrication Device and of the Brake

In the preceding sections 1 and 2, the following threshold speeds are defined:
N_{D}: threshold engaging speed used by the clutch 110 associated with the pump 104 (auxiliary pump) of the lubrication device 100
N_{A}: threshold priming speed of the second pump (main pump) of the lubrication device 100.
N_{R}: threshold braking speed used by the brake 200
N_{F}: threshold locking speed used by the brake 200

For example, these threshold speeds defined in the preceding sections obey the following relationship:

$$0 < {N}_{F} < {N}_{R} < {N}_{A} \leq {N}_{D}$$

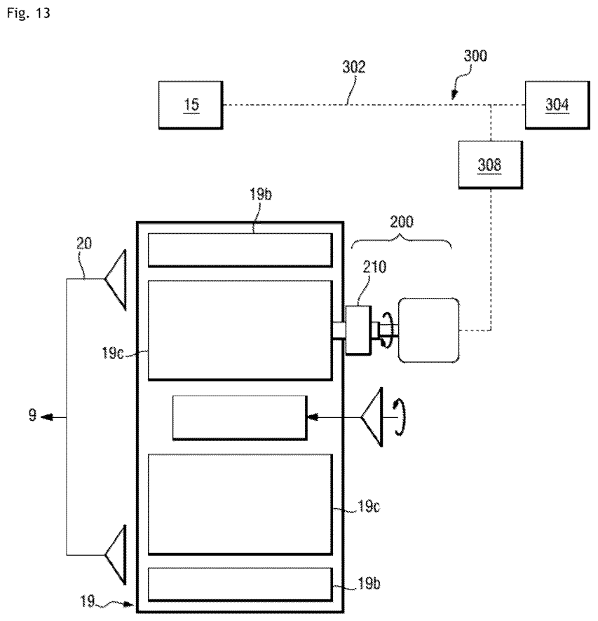

FIG. 13 shows operating regions of the pump 104, when it is an auxiliary pump 104 combined with a main pump. In this embodiment, N_{A}<N_{D}.

The auxiliary lubrication (i.e. provided by the auxiliary pump 104) occurs over the range of speeds [0, N_{D}]. The auxiliary pump 104 can be primed, for example above 2 rpm. The main lubrication is involved over the range of speeds] N_{A}, N_{MAX}]. N_{MAX} is a maximum rotation speed of the drive shaft (not illustrated). For example, N_{MAX} is equal to 12.000 rpm.

The locking performed by the brake 200 occurs over the range [0, N_{F}].

The braking (causing a deceleration without locking) occurs over the range (]N_{F}, N_{R}] (or where applicable over the range [0, N_{R}] if no locking is desired).

Alternatively, the lubrication provided by the pump 104 previously described provides a lubrication over the entire range of possible speeds for the drive shaft, i.e. in the range from 0 to N_{MAX}.

### 4) Sharing of Means for Controlling the Pitch of the Blades and Controlling the Brake

With reference to FIG. 13, the propulsion system comprises a control system 300 for controlling the pitch of the blades 19 of the fan rotor, in particular to control the feathering of the blades 19.

The control system 300 comprises the pitch change mechanism 15 described above, a hydraulic control circuit 302 and a hydraulic fluid source 304.

The hydraulic circuit 302 fluidly connects the source 304 to the pitch change mechanism 15. The hydraulic circuit 302 is configured to convey a fluid from the source 302 to the mechanism 15 to actuate it. Thus, the fluid conveyed by the hydraulic circuit transports a hydraulic energy which forces a displacement of the pitch change mechanism 15, thus modifying the orientation of the blades 19 with respect to the hub, and therefore their pitch. In other words, the pitch change mechanism 15 is hydraulically actuated.

The brake 200 can moreover be configured to lock the rotation of the fan rotor as a function of a command to feather the blades. In other words, any feathering of the blades 19 is accompanied by a locking of the fan rotor 9 by the brake 200. The control system 300 is thus rendered versatile, and there is no need to use a control system dedicated to the brake 200, which leads to savings of space and mass. The control system is simpler than the systems of the prior art, and there is no longer any need to lubricate at low rotation speed (for example via an auxiliary pump), since the engine is no longer running.

Moreover, the brake 200 can be configured to unlock the rotation of the fan rotor 9 as a function of a command to unfeather the blades 19 by the control system 300. This command is simple and effective.

The brake 200 can be configured to be actuated by an energy which also makes it possible to actuate the variation of the pitch of the blades. This makes it possible to render the system 1 more compact, since the brake 200 benefits from a source of energy which is already available nearby to generate a braking/locking force, and allows easier synchronization of control. In other words, the brake 200 takes off a part of the energy devoted to the variation of the pitch of the blades of the fan rotor 9, in order to fulfil its braking/locking function.

For example, the energy used by the brake is a hydraulic energy transported by the hydraulic circuit. In such an embodiment, the brake 200 is hydraulically actuated, just like the pitch change mechanism 15. This is easier to embody than a system involving electrical or mechanical energy, and the system is made more compact, with lower mass.

When the brake 200 is hydraulically actuated, this hydraulic actuation can be connected to the control system 300. More precisely, the brake 200 is fluidly connected to the hydraulic control circuit 302. The hydraulic actuation of the brake 200 can be direct or indirect. The hydraulic actuation can be performed, for example, even if the control system 300 is passive when idle (i.e. in the feathered position or with the brake locked), for example via a counterweight, the control remains hydraulic in order to cancel out the action of the counterweight at a given time.

The control system 300 may further comprise a first delay timer configured to delay the rotational locking with respect to the feathering of the blades. It is thus possible to wait for the feathering to be effective before locking.

The control system 300 may further comprise, for example, a second delay timer configured to delay an unfeathering of the blades with respect to the unlocking of the rotation of the fan rotor.

The use of the first delay timer and/or of the second delay timer makes it possible to reduce restrictions and dimension certain elements more accurately, hence a saving of space and a reduction in mass.

The first delay timer or the second delay timer for example comprises a time counter, and the locking can be triggered when this time counter reaches a predefined time. The first delay timer and the second delay timer may be one and the same delay timer, or else be different delay timers.

On FIG. 13, the first delay timers are represented by a block 308 at the hydraulic circuit 302, it being understood that these delay timers can be incorporated into the brake 200.

FIG. 13 shows the control system 300 combined with a brake 200 in accordance with the embodiment of FIG. 10, in which the element braked by the brake is a satellite 19c of the reducer 19. Of course, the control system 300 as described above can in a variant be combined with the other embodiments of the brake 200 shown previously in section 2, in particular that of FIG. 9, in which the braked element is the sun gear 19a, and that of FIG. 11, in which the braked element is the rotor of the pump 104.

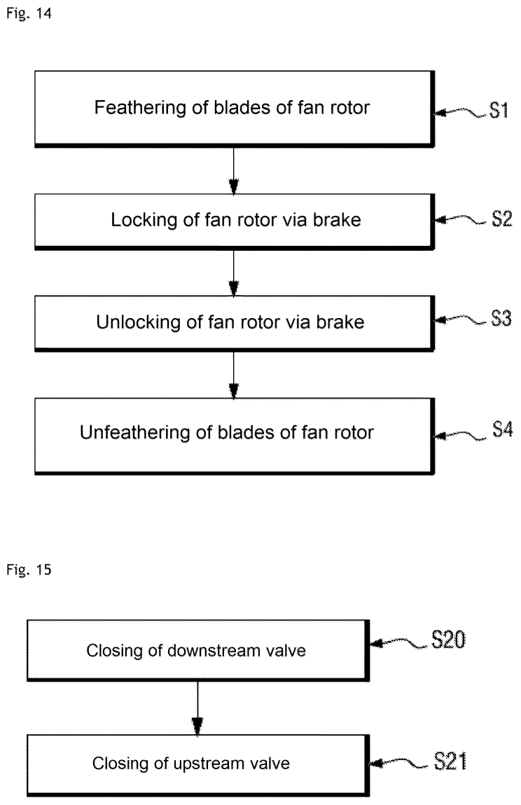

With reference to FIG. 14, a braking method implemented using the control system 300 comprises the following steps.

The control system 300 detects that the feathering of the fan blades must be triggered.

In response to this detection, the control system 300 commands the feathering of the fan blades (step S1). To do so, the hydraulic circuit 302 conveys a fluid from the source 304 toward the pitch change mechanism 19. This fluid transports a hydraulic energy which forces the pitch change mechanism 15 such that this mechanism 15 displaces the fan blades 19 into their feathered position.

As the hydraulic circuit 302 is moreover hydraulically connected to the brake 200, a part of this hydraulic energy actuates the brake 200 such that the brake 200 locks the fan rotor. When the first delay timer is used, this locking occurs after the feathering of the fan blades.

As seen previously, the rotor of the pump 104 may participate, in certain embodiments, in the transmission of the locking force generated by the brake 200 to the reducer 19, which is then passed on to the fan rotor 9. In the embodiments in which the brake 200 comprises the valves 206 and 208, the locking step S2 comprises the following steps shown in FIG. 15: the control system 300 controls, via the fluid travelling through the hydraulic circuit 302, a closing of the downstream valve 206 (step S20), then a closing of the upstream valve 208 (step S21). This causes an overpressure of oil in the pump 104, which causes the locking of the pump rotor.

Subsequently, the control system 300 detects that an unfeathering of the fan blade must be triggered.

In response to this detection, the control system 300 commands an unfeathering of the fan blades (step S3). To do so, the device 304 causes the conveying of the fluid through the hydraulic circuit 302. This fluid transports a hydraulic energy which forces the pitch change mechanism 15 such that this mechanism 15 displaces the fan blades 19 out of their feathered position.

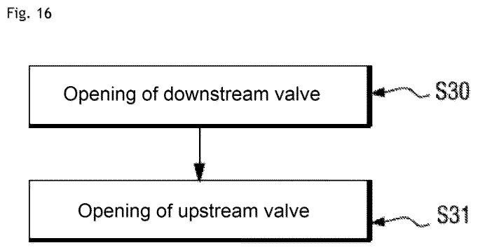

As the hydraulic circuit 302 is moreover connected to the brake 200, a part of this hydraulic energy releases the brake 200 such that the brake 200 stops locking the fan rotor (step S4). When the second delay timer is used, this release occurs before the fan blades come out of feathering. In the embodiments in which the brake 200 comprises the valves 206 and 208, the unlocking step S3 comprises the following steps shown in FIG. 16: the control system 300 controls, via the fluid travelling through the hydraulic circuit 302, an opening of the first downstream valve 206 (step S30), then an opening of the upstream valve 208 (step S31). The pump rotor is then unlocked, which permits the rotation of the rotary elements of the reducer 19 and consequently of the fan rotor 1. Simultaneously, the rotor 104 again starts to supply oil to the reducer 19, which is thus lubricated.

Until now, embodiments have been described in which the brake 200 uses as energy source the control system 30 which serves to vary the pitch of the fan blades 19. In other embodiments, complementary or alternative energy sources may be used for the brake 200, particularly: an air starter, a battery, etc.

### 5) Other Embodiments

Other embodiments of the lubrication device 100, of the brake 200 and/or of the control system 300 may be envisioned for the propulsion system 1.

In particular:
Although FIG. 11 shows only a single brake 200 coupled with a satellite 19c, the propulsion system 1 may comprise several brakes 200 respectively coupled to different satellites 19c of the reducer 19. Using several brakes makes it possible to improve the efficiency and its compactness: specifically, several small brakes used jointly may provide similar braking to that of one large brake, but optimize the bulk; moreover, their redundancy improves the safety of the system.
As already recalled above, the brake 200 can be independent of the pump 104, and more generally of the lubrication device 100. The element braked by the brake 200 is not necessarily a part of the reducer 19: this braked element can specifically be the fan shaft 20 or the drive shaft 11. All these alternatives allow saving of space in the engine.
The brake 200 is not necessarily hydraulically actuated. In a variant, the brake 200 may be actuated using a worm screw, for example a ball screw, etc.
The brake 200 can use one or more sources of energy independent of the control system 300 to vary the pitch of the blades 19, among which: an air starter, a battery, etc.
The lubrication device 100 and/or the brake 200 advantageously combine with a reducer 19 of star type, since this combination leads to a simplification of the structure, and therefore a bulk saving, related to greater ease of integration. It nonetheless remains possible to combine the lubrication device 100 and/or the brake 200 with a reducer of planetary type.
Different strategies may be envisioned: the brake 200 can be engaged by default by the clutch 210, and where applicable can be used in coordination with another brake (for example an electromagnetic brake to recover energy).

1. An aeronautical propulsion system comprising:
a drive shaft;
a fan rotor;
a fan shaft that rotationally drives the fan rotor;
a speed reducer that rotationally couples the drive shaft and the fan shaft, and that is configured to drive the fan shaft at a rotation speed less than a rotation speed of the drive shaft, the speed reducer comprising:
a sun gear rotationally coupled with the drive shaft,
a satellite that meshes with the sun gear,
a ring gear which meshes with the satellite, the ring gear having a diameter greater than a diameter of the sun gear,
a planet-carrier on which the satellite is rotationally mounted, the planet-carrier being fixed with respect to a stator of the aeronautical propulsion system; and
a lubrication device comprising:
a pump comprising a pump rotor, the pump being configured to supply oil to the speed reducer when the pump rotor is in rotation, the pump rotor being rotationally coupled with the satellite, wherein, considered in an axial direction along which the aeronautical extends, the speed reducer is located between the pump and the drive shaft, and
an intake duct that supplies oil to the pump, wherein the intake duct axially traverses the speed reducer.

2. The aeronautical propulsion system as claimed in claim 1, comprising a clutch configured to:
rotationally uncouple the pump rotor from the satellite when the rotation speed of the drive shaft is greater than or equal to a threshold engaging speed, and
rotationally couple the pump rotor with the satellite when the rotation speed of the drive shaft is less than the threshold engaging speed.

3. The aeronautical propulsion system as claimed in claim 2, wherein the lubrication device comprises a second pump distinct from the pump comprising the pump rotor, the second pump being configured to supply oil to the speed reducer when the rotation speed of the drive shaft is greater than or equal to the threshold engaging speed.

4. The aeronautical propulsion system as claimed in claim 2, wherein the threshold engaging speed has a value between 50 revolutions per minute and 800 revolutions per minute.

5. The aeronautical propulsion system as claimed in claim 1, wherein the pump is configured to supply oil to the speed reducer when the pump rotor is in rotation in a first direction of rotation or in a second direction of rotation opposed to the first direction of rotation.

6. The aeronautical propulsion system as claimed in claim 1, further comprising an intermediate gear, the pump rotor being rotationally coupled with the satellite via the intermediate gear.

7. The aeronautical propulsion system as claimed in claim 1, wherein:
the speed reducer comprises a plurality of satellites that mesh with the sun gear,
the lubrication device comprises a plurality of pumps each comprising a pump rotor, the plurality of pumps comprising at least two pumps and at the most as many pumps as there are satellites, each pump rotor being rotationally coupled with a distinct satellite, the lubrication device being configured to lubricate the speed reducer with oil when the pump rotors are in rotation.

8. The aeronautical propulsion system as claimed in claim 1, further comprising a brake configured to lock the rotation of the pump rotor when the rotation speed of the drive shaft is less than a threshold braking speed.

9. The aeronautical propulsion system as claimed in claim 2, wherein the threshold engaging speed has a value between 50 revolutions per minute and 500 revolutions per minute.

10. The aeronautical propulsion system as claimed in claim 2, wherein the threshold engaging speed has a value between 100 revolutions per minute and 300 revolutions per minute.
